(19) United States
(12) Patent Application Publication
(10) Pub. No.: US 2025/0134759 A1
(43) Pub. Date: May 1, 2025

(54) FLEXIBLE STIMULATING DEVICE

(71) Applicant: HYTTO PTE. LTD., Singapore (SG)

(72) Inventors: DAN LIU, Guangdong (CN); JILIN QIU, Guangdong (CN)

(21) Appl. No.: 18/499,094

(22) Filed: Oct. 31, 2023

(51) Int. Cl. A61H 19/00; A61H 23/02

(52) U.S. Cl. CPC A61H 19/34; A61H 19/44; A61H 23/02; A61H 2201/0153; A61H 2201/1669; A61H 2201/1676; A61H 2201/5002; A61H 2201/5025

(57) ABSTRACT

A stimulating device includes a base, at least one stimulation appendage extending from the base, and a drive unit configured to drive each of the at least the stimulation appendage to bend forward or backward within at least one single planar range in response to an operation of a user, thereby resulting in achieving a desired arrangement and maintaining the desired arrangement against pressure.

### TECHNICAL FIELD

The present disclosure relates to stimulating devices and, more specifically, to flexible stimulating devices.

### DISCUSSION OF THE RELATED ART

Stimulation devices are widely used as a means of providing sexual and other forms of stimulation to a user. One popular form of stimulation device is known as the rabbit vibrator which has two stimulation projections that may be used to stimulate two different portions of the user's body at the same time. For example, one stimulation projection might be used to stimulate the clitoris while the other stimulation projection might be used to stimulate the g-spot. However, as the anatomy of each user can be distinct, it is difficult to find a single design that is effective in providing dual stimulation for most users.

To contend with this problem, some rabbit vibrators are adjustable allowing a user to physically bend each projection to a desired shape. However, such stimulation devices might not remain in the desired shape indefinitely and where the user has multiple different desired shapes that she chooses to switch between, it can be difficult and time consuming to manually adjust each projection each time the user desires a change.

### SUMMARY

A stimulating device includes a base, at least one stimulation appendage extending from the base, and a drive unit configured to drive each of the at least the stimulation appendage to bend forward or backward within at least one single planar range in response to an operation of a user, thereby resulting in achieving a desired arrangement and maintaining the desired arrangement against pressure.

A stimulating device includes a handle portion that is shorter on a first portion thereof than on a second portion thereof. A first stimulation appendage extends from the first portion thereof. A second stimulation appendage extends from the second portion thereof. A first actuator is configured to control a degree of curvature of the first stimulation appendage. A second actuator is configured to control a degree of curvature of the second stimulation appendage.

A stimulating device includes a base, a controller disposed within the base, a stimulation appendage extending from the base and configured to curl inwardly and outwardly under the direction of the controller, and a stimulating component disposed in a side of the stimulation appendage that is opposite to a side thereof contacting the base. The controller, the stimulation appendage, and the stimulation component are powered by a power source disposed within the base.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a perspective view of a stimulating device in accordance with exemplary embodiments of the present invention;

FIG. 2 is a cutaway view of a stimulating device in accordance with exemplary embodiments of the present invention;

FIG. 3 is an exploded view of a stimulating device in accordance with exemplary embodiments of the present invention;

FIG. 4 is a perspective view illustrating a multi-jointed hinge in accordance with example embodiments of the present disclosure;

FIG. 5 is a perspective view of a stimulating device in accordance with an embodiment of the present disclosure;

FIG. 6 is a perspective view illustrating a stimulating device including rotary knobs in accordance with example embodiments of the present disclosure;

FIG. 7 is a cutaway view illustrating the stimulating device including rotary knobs as illustrated in FIG. 6;

FIG. 8 is an exploded view of the stimulating device including rotary knobs as illustrated in FIG. 6;

FIGS. 9 and 10 are diagrams illustrating a manner of arcing of the pair of stimulation members in accordance with example embodiments of the present disclosure;

FIG. 11 is an illustration showing a perspective view and a cutaway view of a stimulating device in accordance with an exemplary embodiment of the present disclosure;

FIG. 12 is a simplified drawing of mechanical structure of a stimulating device in accordance with an exemplary embodiments of the present invention;

FIG. 13 is a perspective view of a stimulating device in accordance with exemplary embodiments of the present invention;

FIG. 14 is a cutaway view of a stimulating device in accordance with exemplary embodiments of the present invention;

FIG. 15 is an exploded view of a stimulating device in accordance with exemplary embodiments of the present invention;

FIGS. 16A-16F are views illustrating various morphologies of a stimulating device in accordance with exemplary embodiments of the present invention; and

FIG. 17 is an anatomical diagram illustrating various anatomical locations that may be stimulated by the flexile stimulating device in accordance with exemplary embodiments of the present disclosure.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present disclosure relate to a stimulation device having two projections, referred to herein as stimulation members, that are independently adjustable to a desired angle and shape for use in stimulating two parts of a user's body at the same time. The desired angles and shapes are electronically implemented so that the user may quickly and easily switch between multiple presets that she has programmed or customized. The presets may also be animated so as to perform a desired movement plan that may be repeated, rather than simply assuming a single desired arrangement. Presets may be programmed either by inputting instructions though an electronic device such as a smartphone or a computer that might be paired to the stimulation device, or by placing the stimulation device into a learning mode whereby either a static position or an animated routine is recorded as it is controlled by the user so that the user may playback a recorded static arrangement or animated routine. Additionally, the stimulation device may be preprogrammed for a range of different static positions and/or animated routines. In each position or animated routine, the two stimulation members may be independently arranged so that the angle of one is not dependent upon the angle of the other. However, mechanical and/or programmed safeguards may be used to prevent the two stimulation members from being driven so as to make contact with each other and/or push past one another (e.g., collide).

According to some embodiments of the present disclosure, the stimulation device may be remotely controllable, for example, over a wide area network such as the Internet, so that a second user may control the desired arrangement of each projection (stimulation member) so as to stimulate the first user in a desired fashion. This may be done using a control panel that is accessible over a website or a mobile application, the control panel mirroring the buttons of the stimulation device and/or providing a user interface to select from between preprogramed static positions and/or animated routines.

Moreover, the first user of the stimulation device may be a content creator (e.g., a live streamer) and remote control of the stimulation device may be granted to a viewer of the content by way of an online control panel that is accessible to the viewer. This control may be provided automatically upon the satisfaction of predetermined conditions such as the issuance of a monetary tip from the second user to the content creator, with different functionality being provided to the control of the second user based on a set of tiered conditions.

The stimulation device, in accordance with exemplary embodiments of the present disclosure, may include a handle portion (e.g., a base) with one or more stimulation members projecting therefrom. Each stimulation member may be a finger-like appendage including a plurality of joint elements that may be referred to herein as rods. The rods may be joined to one another to create a multi-jointed hinge. The configuration of each rod may be such that it is free to rotate backwards or forwards in a lateral direction, with some limited degree of freedom, so that the entirety of the multi-jointed hinge can achieve an arcing shape. For example, while each multi-jointed hinge may be able to bend left and right, the hinge arrangement between each neighboring jointed rod may prevent bending in other directions such as front and back, or diagonally. However, in other embodiments, front and back motion may be permitted with left and right motion blocked. In some embodiments, each stimulation member may be rotatably mounted to the handle portion so that it may be rotated to allow for motion in any arbitrary direction, while maintaining the condition that the stimulation member can only arc forward and backward within a single plane, although this plane may be changed by the aforementioned rotation. This rotation of the stimulation member may be performed either by an electric motor or manually, for example, by the adjustment of a rotary knob disposed on the handle portion.

Each stimulation member may include an elongated elastic component that may be made of a metal or another bendable (but generally shape-holding) material. The stimulation member may have a substantially flat rectangular shape and may be fixed to a forward-most rod (rod farthest from the handle portion) of the multi-jointed hinge such that when the elongated elastic component is pulled in, the stimulation member bends to one side and when the elongated elastic component is pushed out to neutral, the stimulation member stands out straight. When the elongated elastic component is pushed out past neutral, the stimulation member bends on another side that is opposite to the aforementioned one side, with both directions of motion being within a single plane, as described above.

It is to be understood herein that the elongated elastic components are elastic in so far as their ability to be bent and return to their original shape but are not necessarily stretchable.

The actuation of the elongated elastic component may be implemented by a motor that turns a screw so as to translate rotational motion of the motor into lateral motion. The elongated elastic component may be connected to the screw so as to achieve lateral motion needed to extend out and back. Alternatively, the rotational motor may wind and unwind the elongated elastic component thereover so as to achieve the needed lateral motion. One or more gears may be used to control the spin characteristics of the motor and/or to implement bidirectional turning. Alternatively or additionally, adjusting the supply voltage may be used to control the speed and direction of the motor.

A protective covering or skin may be disposed over each of the stimulation members and encompassing all of the constituent rods. Within this skin a stimulating component, such as a vibrating motor, may be disposed. The stimulating component may be disposed within the forward-most rod of the multi-jointed hinge and may be electrically connected to the base of the stimulation device by wires or other conductive elements that are arranged under the skin and, for example, through the multi-jointed hinge, so as to be connected to a controller device and a power source that are disposed within the base. The base may be the handle of the stimulation device.

Alternatively or in addition to motorized control, the degree of arcing of the stimulation members may be controlled by the manual spinning of rotary knobs disposed on the base of the stimulation device, in a manner similar to how rotary knobs may be used to change the rotation of the stimulation members.

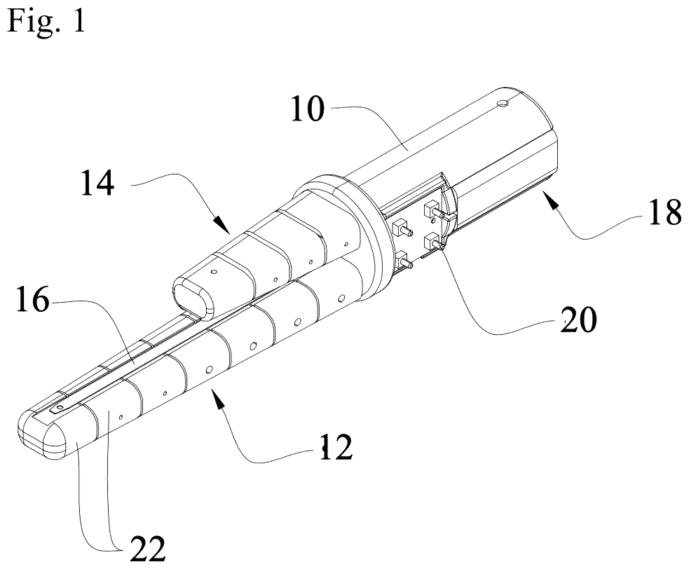

FIG. 1 is a perspective view of a stimulating device in accordance with exemplary embodiments of the present invention. The stimulating device may include a handle portion 18 that is covered by a housing 10. A control module disposed within the handle portion 18 may include one or more buttons 20 that may be used to allow the user to control the device. The handle portion 18 may also include other input/output elements such as display screens, touchscreens, and the like.

The stimulating device may include a first stimulation member 12 and a second stimulation member 14. The two stimulation members 12 and 14 may be the same size or, as shown, the first stimulation member 14 may be longer than the second stimulation member 12. This length difference may be achieved, for example, by including more jointed rod elements 22 within the first stimulation member 12 than the second stimulation member 14. Each stimulation member 12 and 14 may include an elongated elastic component. For example, the first stimulation member 12 may include a first elongated elastic component 16. The elongated elastic components are shown as being disposed along the inside surface of the stimulation member (i.e., the first elongated elastic component 16 may face the second stimulation member 14). As mentioned above, pulling the first elongated elastic component 16 in the direction into the handle portion 18 results in the first stimulation member 12 arcing in the direction towards the second stimulation member 14 while pushing the first elongated elastic component 16 in the direction way from the handle portion 18 results in the first stimulation member 12 arcing in the direction away from the second stimulation member 14. The second stimulation member 14 may be set up as a mirror image of the first stimulation member 12 and so the directionality of the arcing would be mirrored as well.

The pulling and pushing of the elongated elastic components is performed by internal mechanical elements of the handle portion, as will be discussed in greater detail below.

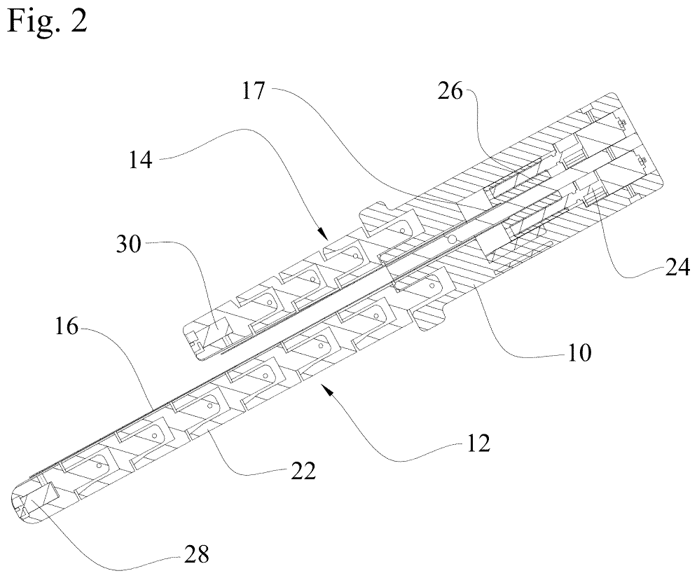

FIG. 2 is a cutaway view of a stimulating device in accordance with exemplary embodiments of the present invention. As can be seen from this view, within the housing 10, a first drive unit for driving the first stimulation member 12 may be disposed and a second drive unit for driving the second stimulation member 14 may be disposed. The first elongated elastic component 16 is connected to the first drive unit 24 and the second elongated elastic component 17 is connected to the second drive unit 26. Each drive unit 24 and 26 controls the degree of extension of its corresponding elongated elastic component 16 and 17 and in this way, the arcing of the stimulation members may be controlled by the action of the drive units, which may be under the control of a control unit that is also disposed within the housing 10.

As can be seen from this figure, each rod 22 is hingedly connected either to the handle portion 18 or another rod 22 and this connection hinge allows for limited rotation backwards or forwards within a single plane. Within the forward-most rod of each stimulation member a stimulating component may be disposed. For example, the forward-most rod of the first stimulation member 12 may include a first stimulating component 28 disposed therein and the forward-most rod of the second stimulation member 14 may include a second stimulating component 30 disposed therein. Each stimulating component may be a vibrating motor.

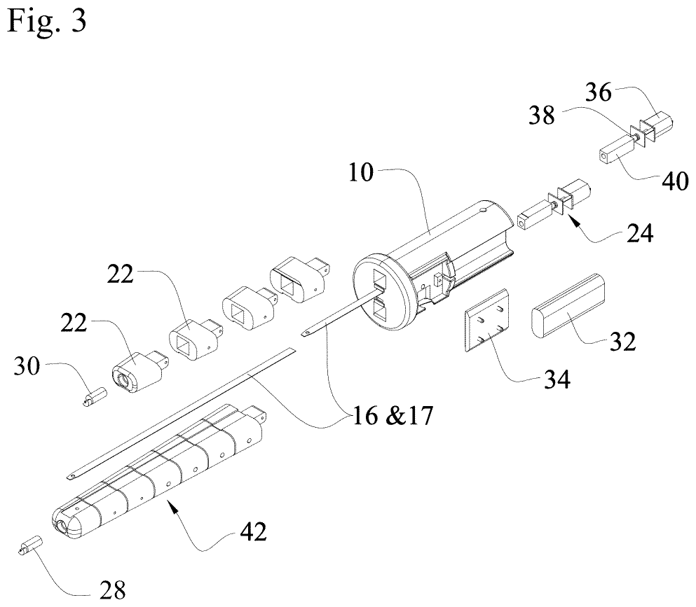

FIG. 3 is an exploded view of a stimulating device in accordance with exemplary embodiments of the present invention. As described above, the housing 10 includes a first drive unit 24 and a second drive unit 26. While these drive units are substantially identical to one another, different element are shown for each drive unit in the interest of providing a simplified representation but it is to be understood that each drive units include all of the elements shown for the other drive unit.

The second drive unit is shown as including a rotating motor 36 and a screw 38. The rotating motor 36 turns the screw 38 and in so doing either pulls in or pushes out the second elongated elastic component 16. The motors 36 are under the electrical control of a control module 34 that is also disposed within the housing 10 and electrical power is supplied to the motors 36 by a battery 32. The control module 34 may also include circuitry and ports for charging the battery 32 and may also include a processor, memory, data I/O functionality, and various other electronic components needed to implement the described functionality. For example, the control module 34 may include Bluetooth capability for communicating with a host smartphone or computer and flash memory for storing the aforementioned static positions and/or animated routines.

Each stimulation member may include a set of rods 22 that together form a multi-jointed hinge 42 that is capable of bending forward and backward in a plane. The forward-most rod of each stimulation member may include a cavity for receiving respective first and second stimulating components 28 and 30 and these stimulating components may be electrically connected to the control module 34 by wires or other conductors that run along or thorough the multi-jointed hinges 42.

The construction of the various rods 22 may be appreciated from this figure, with each rod being smaller than the next from the housing 10 to the forward-most rod. This gives each stimulation member a tapered shape, although some embodiments use commonly sized rods 22 and do not have the illustrated tapered shape. Moreover, each rod has a wide forward portion with a cavity and a narrow backward portion such that the narrow backward portion of one rod can mate within the cavity of the wide forward portion of the next rod, and so on. The narrow backward portion may have a pair of bumps that may engage with a corresponding pair of recesses within the cavity of the wide forward portion so that the two proximate rods may be snapped into one another, although the narrow backward portion may have the recesses while the cavity of the wide forward portion may have the bumps or both sections may have through holes for receiving a pin that is disposed through all through holes thereby creating the joint. Other arrangements may also be used and the instant invention is not necessarily limited to these approaches.

Moreover, the rods 22 may each have a channel so that the multi-jointed hinges 42 have channels for accommodating the elongated elastic components. The forward-most rods may also have a means of attachment for connecting the elongated elastic components thereto, such as an opening for a rivet that penetrates the elongated elastic component and affixes it to the forward-most rod.

The geometric arrangement of the top and bottom of each rod is designed so as to prevent side to side bending but permit front to back bending.

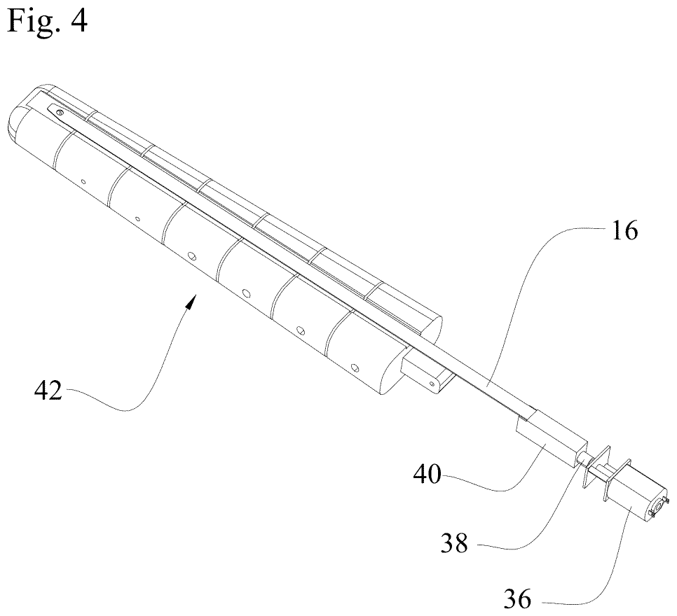

FIG. 4 is a perspective view illustrating a multi-jointed hinge in accordance with example embodiments of the present disclosure. As can be seen, the multi-jointed hinge 42 includes an elongated elastic component (e.g., a first elongated elastic component 16) that sits within the above-described channel and is fixed to the forward-most rod on a forward side and fixed to a nut 40 on the backward side. The nut 40 is threaded to a screw 38 and the nut 40 is mounted within the housing 10 so as to prevent it from rotating such that as the screw 38 rotates within the nut 40, the nut 40 is pushed either forward or backward. As the multi-jointed hinge 42 is prevented from moving forward and backward, for example, by hingedly joining the backward-most rod to the housing 10, the movement of the elongated elastic component within the channel causes the arcing of the multi-jointed hinge 42. Physical or programmed means may be used to prevent over extension or over contraction of the elongated elastic component.

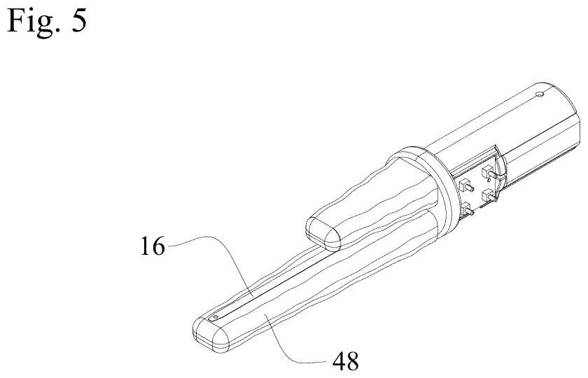

FIG. 5 is a perspective view of a stimulating device in accordance with another embodiment of the present disclosure. According to this approach, each stimulation member 12 and 14 need not include multi-jointed hinges made of rods. Rather, each stimulation rod may include a single malleable rod, for example, made of elastic plastic or metal with the elongated elastic components. In this embodiment, the malleable rods may be blocked from undesirable bending outside of the plane of arcing described above by the rigidity of the elongated elastic components or by some other means known in the art.

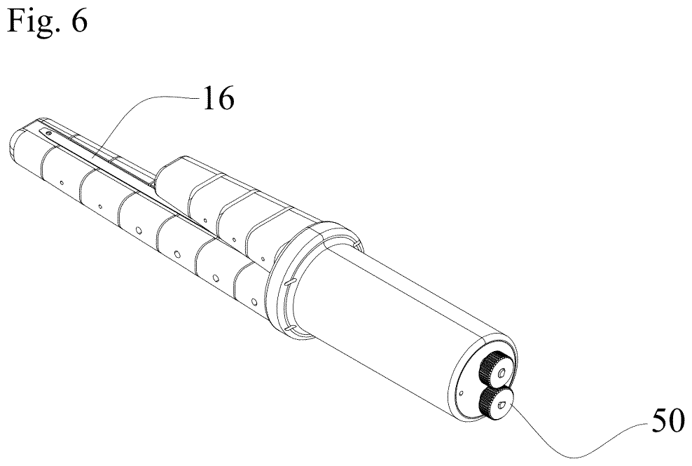

As mentioned above, rotary knobs may be used to manually extend and retract the elongated elastic components and/or rotary knobs may be used to manually rotate the plane of arcing of each stimulation member. FIG. 6 is a perspective view illustrating a stimulating device including rotary knobs in accordance with example embodiments of the present disclosure. As can be seen from the above, there may be multiple rotary knobs and a first rotary knob 50 may be designed to rotate the plane of arcing of the first stimulation member 12 or to manually retract/extend the first elongated elastic component. When the first rotary knob 50 is used to retract/extend the first elongated elastic component, it may either be used as a manual override to the electronic components, used instead of the electronic components that may be omitted, as a means of fine tuning the extension with a degree of fineness that cannot be provided by the rotating motors, or as a means of calibrating the action of the rotating motors so as to ensure that the stimulation members actually extend straight when the control module believes that they are fully straightened.

According to some examples of the present disclosure, the rotary knobs are not mechanically linked to the screws but rather, are linked to potentiometers that electrically determine knob rotation and send a corresponding signal to the control module which then controls the corresponding drive unit in proportion to the spinning of the knob. In this way, the knobs to not physically control the bending of the stimulation members but rather operate as electronic controls for the bending of the stimulation members. Pressing in each knob may also constitute a control similar to a button.

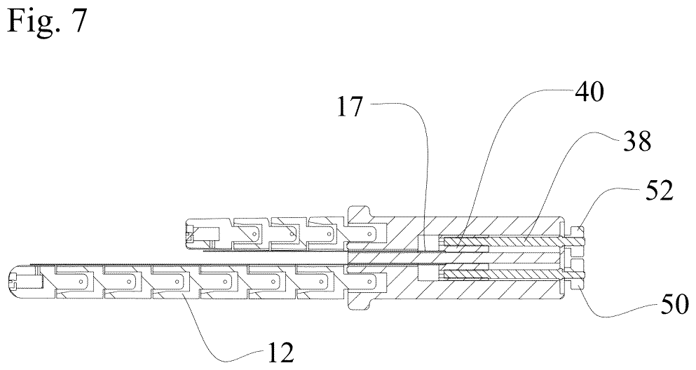

FIG. 7 is a cutaway view illustrating the stimulating device including rotary knobs as illustrated in FIG. 6. This arrangement show the use of a first rotary knob 50 and a second rotary knob 52 as a manual means of rotating the screw 38 in the absence of the rotating motors. Here, each rotary knob (e.g., 52) turns a corresponding screw (e.g., 38) and the screw turns within the nut (e.g., 40), which is prevented from rotation by its mounting within the housing such that the nut moves forward and backward as the knob is turned one way or the other way. The nut is affixed to the elongated elastic component (e.g., 17) and in this way the stimulation members are made to arc in the desired direction to the desired extent.

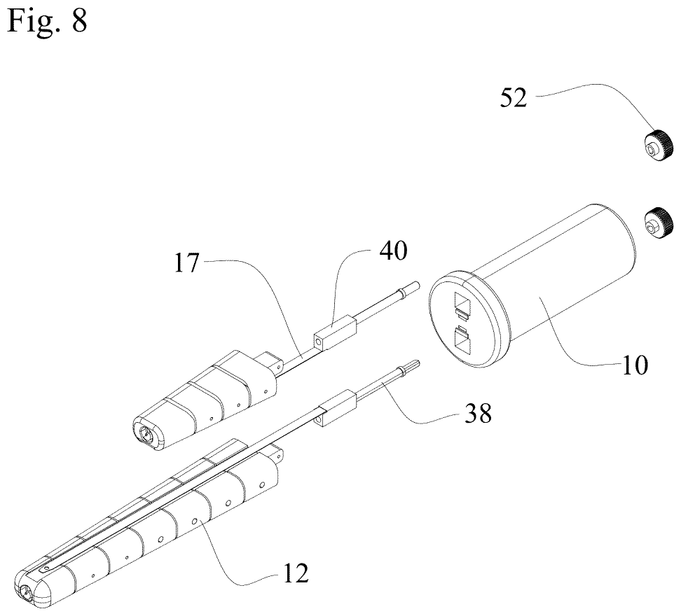

FIG. 8 is an exploded view of the stimulating device including rotary knobs as illustrated in FIG. 6. As can be seen from this figure, the nut and screw are disposed within a cavity of the housing so that the screw connects directly to its corresponding knob, through the housing.

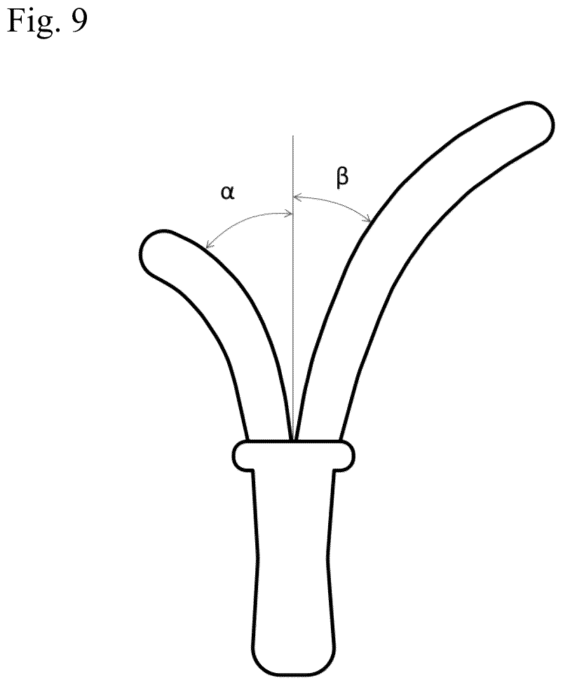

FIGS. 9 and 10 are diagrams illustrating a manner of arcing of the pair of stimulation members in accordance with example embodiments of the present disclosure. As can be seen from FIG. 9, the stimulation members may be arced away from one another with the second (e.g., shorter) stimulation member achieving an angle α with respect to straight and the first stimulation member (e.g., longer) achieving an angle β. As seen in this figure, the second stimulation member has an angle α that may be defined as positive, where straight is the angle zero and the first stimulation member has an angle β that may be defined as negative.

As can be seen from FIG. 10, the stimulation members may be arced in the same direction as one another with the second (e.g., shorter) stimulation member achieving an angle α with respect to straight and the first stimulation member (e.g., longer) achieving an angle β. As seen in this figure, the second stimulation member has an angle α that may be defined as positive, where straight is the angle zero and the first stimulation member has an angle β that may also be positive.

While it might be possible for both stimulation members to be arced toward one another, as mentioned above, this motion may be mechanically or software limited to prevent the stimulation members from pushing into one another.

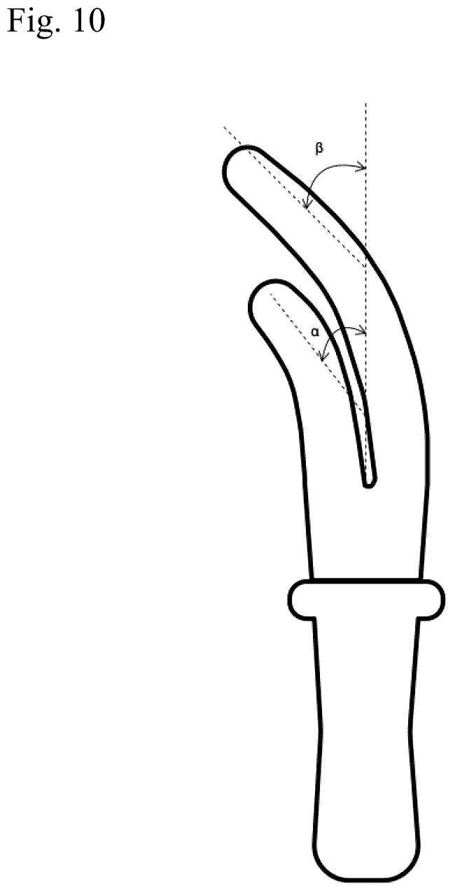

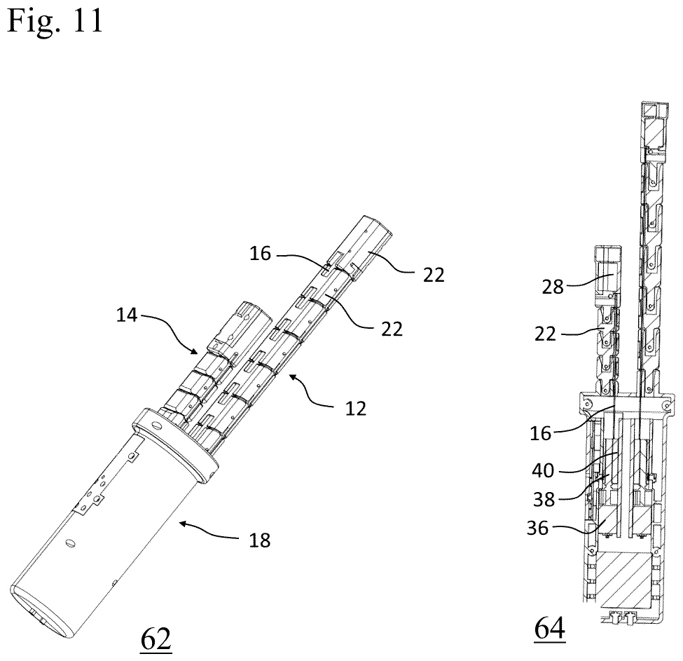

FIG. 11 is an illustration showing a perspective view 62 and a cutaway view 64 of a stimulating device in accordance with an exemplary embodiment of the present disclosure. As can be seen here, the elongated elastic components 16 are disposed within the stimulation member 12 and 14, rather than on their outer surface and the rods 22 are shaped with the cavity of the wide forward portion having a tapered top opening that allows for limiting the bending of each rod with respect to the prior rod.

By disposing the elongated elastic components 16 within the stimulation member 12 and 14, rather than on their outer surface, the middle rods (those rods other than the farthest from the handle) may be prevented from bowing out and away from the corresponding elongated elastic component 16.

The above-mentioned taper may be identical for each rod so that the multi-jointed hinge arcs evenly or the taper may be adjusted for each rod so that more arcing can be achieved towards the front (forward side) of the stimulation members than toward the back (handle side) of the stimulation member. The placement of the battery as occupying an entirety of the lower section of the handle is shown and two charging pins are also shown on the bottom of the handle so as to facilitate charging of the battery, for example, by inserting the handle into a charging dock.

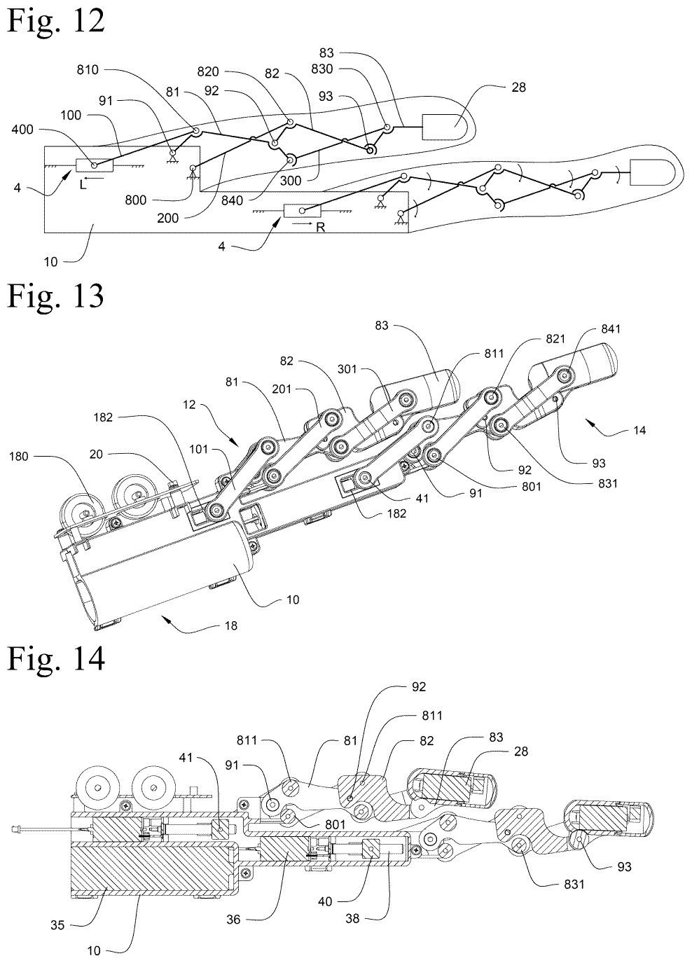

FIG. 12 is a simplified drawing of mechanical structure of a stimulating device in accordance with an exemplary embodiments of the present invention. As can be seen from this view, within the housing 10, a first drive unit for driving the first stimulation member 12 may be disposed and a second drive unit for driving the second stimulation member 14 may be disposed, and the drive units may each be linear reciprocating mechanisms 4.

In the depicted figure, each stimulation member 12 and 14 is equipped with a set of rods and a driving assembly including at least one rigid driving rod, and the figure allows for an observation of the distinct construction of these rods. Notably, each stimulation members 12 and 14 may include three rods. The first rod 81 is connected to a main body of the handle portion 18 via a first hinge pin 91, establishing a coupling. Similarly, a second hinge pin 92 facilitates the connection between the first rod 81 and the second rod 82. Moreover, a third hinge pin 93 enables the coupling of the second rod 82 with the third rod 83. Collectively, these rods form a multi-jointed hinge 80.

From this view, it is apparent that stimulation members 14 and 16 may further include three rigid driving rods that link the linear reciprocating mechanisms 4 to the various rods and hinge pins, for example, a first rigid driving rod 100, a second rigid driving rod 200, and a third rigid driving rod 300. Furthermore, a third rod 83, positioned at the forefront of the multi-jointed hinge, may encompass a stimulating component, such as a vibrating motor 28.

The proximal end of the first rigid driving rod 100, can be rotatably connected to a hinge shaft 400 that is part of the linear reciprocating mechanism 4, and the distal end of the first rigid driving rod 100, may be rotatably connected to the first rod 81 via a first hinge point 810.

The proximal end of the second rigid driving rod 200, can be rotatably connected to the handle portion 18 via a fifth hinge point 800, which may be fixed to the distal end of the handle portion 18. Furthermore, the distal end of the second rigid driving rod 200, can be rotatably connected to the second rod 82 via a second hinge point 820.

The distal end of the third rigid driving rod 300, can be rotatably connected to the third rod 83 via a third hinge point 830, which may be secured to the third rod 83. Furthermore, the proximal end of the third rigid driving rod 300, can be rotatably connected to the first rod 81 via a fourth hinge point 840, which may be fixed to the first rod 81.

Regarding the second stimulating member 14, when the linear reciprocating mechanism 4 is activated, the hinge shaft 400 moves linearly in the direction indicated by the L arrow in FIG. 12. This linear motion causes the first rigid driving rod 100 to drive the first rod 81 to rotate in a counterclockwise direction relative to the first hinge pin 91.

The counterclockwise rotation of the first rod 81 further drives the second rigid driving rod 200 to rotate in a counterclockwise direction with respect to the fifth hinge point 800. Similarly, it may also drive the third rigid driving rod 300 to rotate in a counterclockwise direction with respect to the third hinge point 830. The counterclockwise rotating second rigid driving rod 200 then drives the second rod 82 to rotate in a counterclockwise direction relative to the second hinge pin 92. Finally, the second rod 82, in cooperation with the counterclockwise rotation of the third rigid driving rod 300, causes the third rod 83 to rotate in a counterclockwise direction relative to the third hinge point 830.

As a result of the actions of the interconnected rods, the second (e.g., shorter) stimulation member 14 achieves a specific orientation, making an angle α with respect to a straight centerline, which is defined as an inwardly curl, as shown in FIG. 9. The described mechanism enables the transmission and conversion of linear motion into rotational motion through the interconnected rods and hinge points, allowing for the controlled positioning of the stimulus member to any desired extent.

Regarding the first stimulating member 12, when a linear reciprocating mechanism 4 is activated, the hinge shaft 400 moves linearly in the direction indicated by the R arrow in FIG. 12. This linear motion causes the first rigid driving rod 100 to drive the first rod 81 to rotate in a clockwise direction relative to the first hinge pin 91.

The clockwise rotation of the first rod 81 further drives the second rigid driving rod 200 to rotate in a clockwise direction with respect to the fifth hinge point 800. Similarly, it also drives the third rigid driving rod 300 to rotate in a clockwise direction with respect to the third hinge point 830. The clockwise rotating second rigid driving rod 200 then drives the second rod 82 to rotate in a clockwise direction relative to the second hinge pin 92. Finally, the second rod 82, in cooperation with the clockwise rotation of the third rigid driving rod 300, causes the third rod 83 to rotate in a clockwise direction relative to the third hinge point 830.

As a result of the actions of the interconnected rods, the first (e.g., longer) stimulation member 12 achieves a specific orientation, making an angle β with respect to a straight centerline, which is defined as an outwardly curl, as shown in FIG. 9. The described mechanism enables the transmission and conversion of linear motion into rotational motion through the interconnected rods and hinge points, allowing for the controlled positioning of the first stimulation member 12.

As a specific embodiment, FIG. 13 is a perspective view of a stimulating device in accordance with exemplary embodiments of the present invention. The stimulating device may include a handle portion 18. A control module disposed within the handle portion 18 may include one or more buttons 20 and/or one or more rotary knobs 180 that may be used to allow the user to control the device. The handle portion 18 may also include other input/output elements such as display screens, touchscreens, and the like.

The arrangement of rods and hinge pins may be well appreciated from this figure with the linear reciprocating mechanisms being shown as elements 182. The rods are shown by elements 101, 201, and 301. The hinge points are shown by elements 41, 811, 801, 821, 831, and 841. FIG. 14 is a cutaway view of a stimulating device in accordance with exemplary embodiments of the present invention. The stimulating device may include a first stimulation member 12 and a second stimulation member 14. The two stimulation members 12 and 14 may be the same size or, as shown, the first stimulation member 14 may be longer than the second stimulation member 12. This length difference may be achieved, for example, by moving the second stimulating member 14 back a distance in the direction of where the handle portion 18 is located.

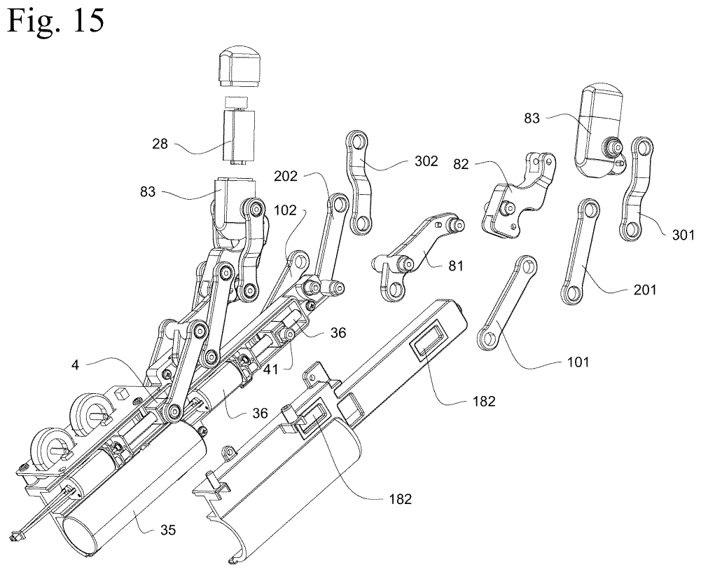

The reference numerals depicted here represent corresponding elements to what has already been shown. However, it is noted that the power source here may be a rechargeable battery 35. FIG. 15 is an exploded view of a stimulating device in accordance with exemplary embodiments of the present invention. Reference to FIG. 13-15, As can be seen from this view, within the housing 10, a first drive unit for driving the first stimulation member 12 and a second drive unit for driving the second stimulation member 14 may be disposed. Each drive unit includes a nut 40 threaded to a screw 38 and the nut 40 is mounted within the housing 10 so as to prevent it from rotating such that as the screw 38 rotates within the nut 40. The nut 40 is pushed either forward or backward. In the handle portion 18, there are a pair of guide slots 182 specifically positioned to align with the movement path of the nut 40. These guide slots 182 correspond to a pair of shafts 41 that are located on either side of the nut 40 and pass through their respective guide slots 182. Notably, these shafts 41 have the capability to slide linearly along the guide slots 182 as the nut 40 engages in linear movement. Each stimulation members 14 and 16 may include three rods each, the first rod 81 is connected to a main body of the handle portion 18 via a first hinge pin 91, thereby establishing a coupling. Similarly, a second hinge pin 92 facilitates the connection between the first rod 81 and the second rod 82. Moreover, a third hinge pin 93 enables the coupling of the second rod 82 with the third rod 83. Collectively, these rods form a multi-jointed hinge.

From these views, it is apparent that stimulation members 14 and 16 further includes three pairs of rigid driving rods each. The proximal end of two first rigid driving rods 101 and 102, can be rotatably connected to a pair of shafts 41 that are part of the nut 40. Furthermore, the distal end of these two first rigid driving rods 101 and 102, can be rotatably connected to a first rod 81 via a pair of first hinge points 811, which are fixed near the upper portion of the first rod 81. Element 181 depicts the linear reciprocating mechanism.

The proximal end of two second rigid driving rods 201 and 202, can be rotatably connected to the handle portion 18 via a pair of fifth hinge points 801, which are fixed to both sides of the distal end of the handle section 18. Furthermore, the distal end of these two second rigid driving rods 201 and 202, can be rotatably connected to a second rod 82 via a pair of second hinge points 821, which are fixed near the upper portion of the second rod 82.

The distal end of these two third rigid driving rods 301 and 302, can be rotatably connected to a third rod 83 via a pair of third hinge points 831, which are secured to either side of the third rod 83. Furthermore, the proximal end of two third rigid driving rods 301 and 302, can be rotatably connected to the first rod 81 via a pair of fourth hinge points 841, which are fixed to both sides of the distal end of the first rod 81.

The third rod 83, positioned at the forefront of each stimulation member 12 and 14, encompasses a cavity designed to accommodate the respective first and second stimulating components, such as vibrating motors. These stimulating components, in turn, can be electrically connected to the control module 34 through the utilization of wires or other conductors. These wires or conductors traverse the multi-jointed hinges, either running alongside them or passing through them.

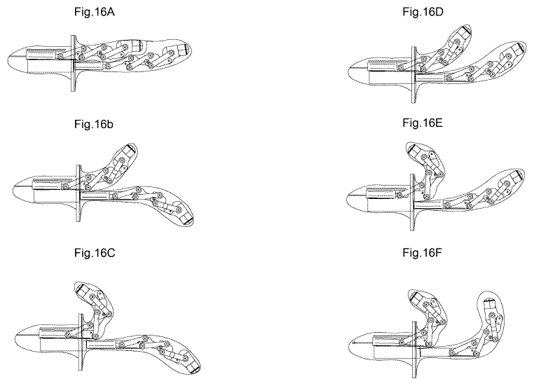

FIGS. 16A-16F are views illustrating various morphologies of a stimulating device in accordance with exemplary embodiments of the present invention. Through separate operation of the first and second drive units by the user, the first and second stimulation members 12 and 14 can bend into various forms, as illustrated in FIGS. 16A-16F. This bending is made possible by their respective plurality of rigid driving rods which are configured to drive the bending of the multi-jointed hinge. By bending into different shapes, the vibration motors 28 located at the end of each stimulation member can simultaneously come into contact with different erogenous zones of the human body. This allows for targeted and simultaneous stimulation of multiple areas.

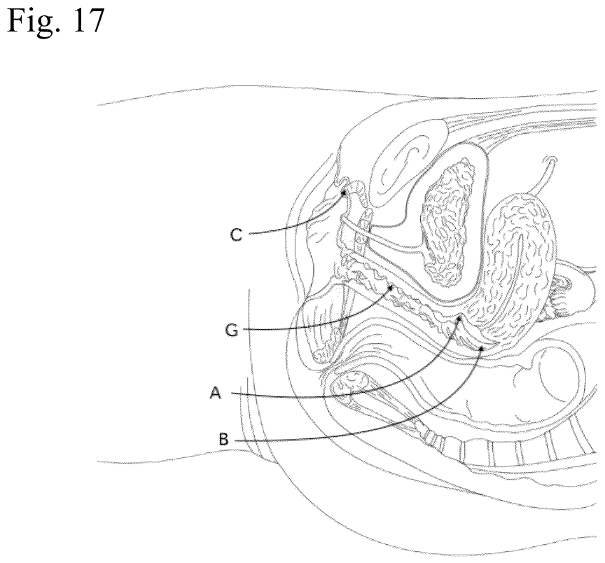

In an initial state, as shown in FIG. 16A, the first and second stimulation members 12 and 14 can be arranged close together and inserted into a user's body (e.g., a female vagina or a male/female anus). While the first and second stimulation members 12 and 14 are inserted within the user's body, the first and second stimulation members 12 and 14 can, depending on the user's operation, be capable of realizing a change in morphology when they are inside the user's body to enable the vibration motors to stimulate a specific sexually sensitive area (e.g., the A-point, B-point, C-point and G-point of the FIG. 17) within the user's body. FIG. 17 is therefore an anatomical diagram illustrating various anatomical locations that may be stimulated by the flexile stimulating device in accordance with exemplary embodiments of the present disclosure.

The stimulation mode as shown in FIG. 16B can stimulate the G-point and the B-point at the same time, the stimulation mode as shown in FIG. 16C can stimulate the C-point and the B-point at the same time, the stimulation mode as shown in FIG. 16D can stimulate the G-point and the A-point at the same time, the stimulation mode as shown in FIG. 16E can stimulate the C-point and the A-point at the same time, the stimulation mode as shown in FIG. 16F can stimulate the C-point and the G-point at the same time.

In order to avoid the stimulation device not being able to be pulled out of the user's body due to the changed morphology that may occur one inside the body, a panic button can be provided, and this panic button, when operated, can force the first and second stimulation members 12 and 14 to return to their initial state (e.g., put the first and second stimulation members 12 and 14 together), so as to enable the user to more easily remove the stimulation device without any problem. The panic button can, but is not necessarily limited to being, be a power switch that enables the first and second stimulation members 12 and 14 to be restored to their initial state when the stimulation device is powered down, and it will be appreciated that this scenario may be implemented upon a determination that the battery is nearly depleted. In one embodiment, pressure sensors may be arranged on the surfaces of the stimulation appendages 12 and 14 to detect whether they are inside a human body, and if both the stimulation appendages 12 and 14 have been inserted a human body, to limit the extent to which the stimulation appendage 12 are curled, for example, to avoid the stimulus appendages 12 from being flexed into the form of FIGS. 16C, 16E, and 16F.

While exemplary embodiments of the present disclosure have largely been described in terms of electronic control of the stimulation members, the present invention is not necessarily limited thereto, and the stimulation members may be manually adjusted by the user by applying sufficient force to bend each stimulation member 12 and/or 14 into its desired shape. Furthermore, when the user bends the stimulation members 12 and/or 14 into the desired shape, the corresponding position of the nut 40 can be stored in the storage module of the sexual stimulation device through user input. This facilitates the direct bending of the stimulation device into the desired shape based on the user's input whenever it is required for future use. Thus, the desired arrangement may be detected and electronically stored for later use. As discussed above, the control module may include a set of buttons. These buttons may include (but are not necessarily limited to including) a first button for controlling the movement of the first stimulation member, a second button for controlling the vibration of the first stimulation member, a third button for controlling the movement of the second stimulation member, and a fourth button for controlling the movement of the second stimulation member. Each button may have an LED light disposed in its proximity so as to illuminate the button for more easy discovery. The control module may additionally include a power LED that may turn a particular color to show power and another color to show Bluetooth connection. Other controls may be used to lock stimulation member movement, toggle through vibrational modes, toggle through programmed static positions and/or animated routines, record a static position or animated routine, etc. In one embodiment, the first stimulation appendage 12 can be controlled by a first button. The second stimulation appendage 14 can be controlled by a second button. The first button and the second button can be located at different positions in the handheld section such as the two rotary knobs 180 in FIG. 13, or have different shapes, or have different tactile sensations, resulting in the user being able to blindly operate two stimulus appendages 12 and 14 based on two buttons.

As discussed above, a display may be provided for I/O and this display may include a touch screen. The stimulating device may be paired with a host device such as a smartphone or computer for more control functionality and to setup remote control. The display and/or indicator LEDs may also be used to show battery level and the need for recharging. Vibration patterns may also be used to communicate status to the user such as to provide a tactile low battery warning at one or more progressive states of discharge.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A stimulating device, comprising:
a base;
at least one stimulation appendage extending from the base; and
a drive unit, configured to drive each of the at least the stimulation appendage to bend forward or backward within at least one single planar range in response to a first operation of a user, thereby resulting in achieving a desired arrangement and maintaining the desired arrangement against pressure.

2. The stimulating device of claim 1, wherein further comprises a vibratory motor mounted in a distal end of one or more of the at least one stimulation appendage.

3. The stimulating device of claim 1, wherein the stimulating device has at least two stimulation appendages configured to simultaneously stimulate at least two sensitive points of a female human body as at least one of the stimulation appendages bend forward or backward.

4. The stimulating device of claim 1, wherein the stimulating device has two stimulation appendages, the two stimulation appendages close together in response to the first operation of the user to facilitate insertion into the vagina of the female human body and are configured to bend forward or backward within the vagina in response to the operation of the user.

5. The stimulating device of claim 1, wherein the stimulation appendages forcibly close together in response to a second operation of the user or a depleting battery power.

6. The stimulating device of claim 1, further comprising a memory device for storing one or more programs, executed by the controller, for setting the stimulation appendage to a desired degree of curvature.

7. The stimulating device of claim 1, wherein each of the at least one stimulation appendage includes a plurality of joining units tiltably connected to one another.

8. The stimulating device of claim 7, wherein each of the at least one stimulation appendage includes one or more elongated elastic components connected to the plurality of joining units.

9. The stimulating device of claim 8, wherein the driving of each of the at least one stimulation appendage includes pulling on or relaxing tension on the one or more elongated elastic components.

10. The stimulating device of claim 1, wherein each of the at least one stimulation appendage includes a plurality of rods and hinge points configured to implement the bending of the at least one stimulation appendages under the control of the drive unit.

11. The stimulating device of claim 1, wherein the at least one stimulation appendage includes a first stimulation appendage and a second stimulation appendage.

12. The stimulating device of claim 11, wherein the first stimulating appendage is of a different length than the second stimulating appendage.

13. The stimulating device of claim 1, wherein the at least one stimulation appendage includes:
a linear reciprocating mechanism; and
a plurality of hinge points and rods crossing one another and driven by the linear reciprocating mechanism so as to curl the at least one stimulation appendage inwardly or outwardly.

14. The stimulating device of claim 1, wherein the at least one stimulation appendage includes:
a first stimulation appendage including a first linear reciprocating mechanism and a first plurality of hinge points and rods crossing one another and driven by the first linear reciprocating mechanism so as to curl the first stimulation appendage outwardly; and
a second stimulation appendage, longer than the first stimulation appendage, including a second linear reciprocating mechanism and a second plurality of hinge points and rods crossing one another and driven by the second linear reciprocating mechanism so as to curl the second stimulation appendage inwardly or outwardly, towards the first stimulation appendage or away from the first stimulation appendage.

15. A stimulating device, comprising:
a handle portion that is shorter on a first portion thereof than on a second portion thereof;
a first stimulation appendage extending from the first portion thereof;
a second stimulation appendage extending from the second portion thereof;
a first actuator configured to control a degree of curvature of the first stimulation appendage; and
a second actuator configured to control a degree of curvature of the second stimulation appendage.

16. The stimulating device of claim 15, wherein the first stimulation appendage is controlled by a first button, and wherein the second stimulation appendage is controlled by a second button, and wherein the first button and the second button are located at different positions in the handheld section, or have different shapes, or have different tactile sensations.

17. The stimulating device of claim 15, wherein the first actuator is disposed in the first portion, and wherein the second actuator is disposed in the second portion.

18. The stimulating device of claim 14, further including a controller disposed within the handle portion for controlling the first and second actuators, and wherein the controller is configured to be controlled or programmed by a user so as to achieve the degree of curvature of the first and second stimulating appendages.

19. A stimulating device, comprising;
a base;
a controller disposed within the base;
a stimulation appendage extending from the base and configured to curl inwardly and/or outwardly under the direction of the controller; and
a stimulating component disposed in a side of the stimulation appendage that is opposite to a side thereof contacting the base,
wherein the controller, the stimulation appendage, and the stimulation component being powered by a power source disposed within the base.

20. The stimulating device of claim 19, additionally comprising:
one or more additional stimulation appendages extending from the base and configured to curl inwardly and outwardly under the direction of the controller,
wherein when the stimulation appendage is controlled to curl inwardly, the one or more additional stimulation appendages are also controlled to curl inwardly to a separate extent from the stimulation appendage, and
wherein when the stimulation appendage is controlled to curl outwardly, the one or more additional stimulation appendages are also controlled to curl outwardly to a separate extent from the stimulation appendage.
